(19) United States
(12) Patent Application Publication
(10) Pub. No.: US 2024/0070402 A1
(43) Pub. Date: Feb. 29, 2024

(54) METHOD FOR FACTUAL EVENT DETECTION FROM ONLINE NEWS BASED ON DEEP LEARNING

(71) Applicant: VIETTEL GROUP, Ha Noi City (VN)

(72) Inventors: Phat Trien Thai, Tay Ninh Province (VN); Van Tuan Nguyen, Nghe An Province (VN)

(73) Assignee: VIETTEL GROUP, Ha Noi City (VN)

(21) Appl. No.: 18/358,310

(22) Filed: Jul. 25, 2023

(30) Foreign Application Priority Data
Aug. 31, 2022 (VN) 1-2022-05577

(51) Int. Cl. G06F 40/40

(52) U.S. Cl. CPC G06F 40/40

(57) ABSTRACT

The factual event detection method for online news consists of five main steps: Step 1: Preprocess raw text to split a document into sentences and words, find part-of-speech tags (POS tags), and digitize data; Step 2: Encode digitized words and their POS tags into vectors; Step 3: Detect triggers and their event types; Step 4: Concatenate the surrounding encoded vectors of each trigger into an aggregate vector; Step 5: Classify the realis status of each event. The method chosen is used in systems that automatically collect, extract, and analyze data in order to monitor and early warn about the activities of targets mentioned in digital newspapers.

### TECHNICAL ASPECTS OF THE INVENTION

The following invention aims to introduce a detection method for factual events in digital newspapers. In detail, the method has practical application in many automatic systems that include collecting, extracting, and analyzing text data to obtain events and track their related targets, thus providing early warnings about targets' activities to assist humans in making proper decisions and handling the incoming incidents in a timely manner.

### BACKGROUND OF THE INVENTION

In the age of information technology, texts from online news platforms are an abundant source of data that needs to be explored. This calls for a system that automatically collects, extracts, and analyzes such information. The obtained data from this system will be used for subsequent tasks such as tracking history or early warning of targets' actions to assist organizations in taking appropriate and timely decisions.

Nowadays, there are plenty of information extraction systems that try to obtain events from text, but they do not place an emphasis on how to extract the events that actually occur. Specifically, such systems provide structured data about triggers (words that represent events) and arguments (text of participants, location, and time of events). However, these events may be merely hypothetical facts or non-specific mentions, or they are negated as not happening. To overcome the problem, this invention proposes a solution to detect events mentioned as occurring in fact. As a result, the method helps in filtering out unwanted events, lowering error propagation to downstream tasks, and reducing overall system inference time.

### SUMMARY OF THE INVENTION

The purpose of the proposed invention is to detect events that actually occur by employing some deep learning approaches. The detection method is performed through the following steps:
Step 1: Preprocess raw text to split a document into sentences and words, find part-of-speech tags (POS tags), and digitize data. The goal of this step is to generate numerical representations of each word and their corresponding POS tags in a sentence.
Step 2: Encode digitized words and their POS tags into vectors. These vectors carry information about the contextual meaning of words in a sentence and their POS-related features.
Step 3: Detect triggers and their event types. This step employs a neural network with an input layer, a hidden layer, and an output layer to classify whether a word represents any event type (including the “None” event—not the trigger).
Step 4: Concatenate the surrounding encoded vectors of each trigger into an aggregate vector.
Step 5: Classify the realis status of each event. This step employs a neural network with a pattern similar to that of step 3. This model ingests the output from the previous step to yield a three-dimensional vector, with each element representing a label: “ACTUAL”, “GENERIC”, and “OTHER”. The events with the label “ACTUAL” are the expected outcomes of this invention.

The proposed solution focuses on extracting triggers and classifying the realis status of each trigger word into three categories: “ACTUAL”, “GENERIC” and “OTHER”, where “ACTUAL” refers to specific events that are explicitly indicated to have occurred in the past, present, or future; “GENERIC” refers to events that are mentioned without any participants, places, or times; “OTHER” describes the remaining events such as those stated as not happening, believed events, and hypothetical events. The method's output includes the trigger words, their sentence spans, event types, and realis statuses. Since the target is to detect actual events, only triggers labeled “ACTUAL” are processed in the next steps, such as event argument extraction.

### BRIEF DESCRIPTION OF THE DRAWINGS

FIG. 1 illustrates the general flow diagram of the detection method;

FIG. 2 is a drawing depicting the process of encoding words, embedding POS tags, and joining vectors to obtain aggregate vectors;

FIG. 3 shows the neural network of the trigger extraction model and realis classification model.

### DETAILED DESCRIPTION OF THE PREFERRED EMBODIMENT

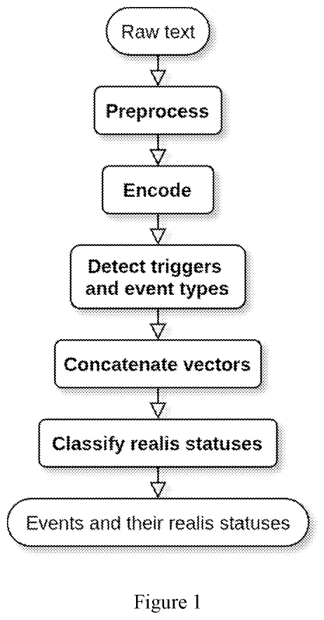

Refer to FIG. 1, the factual event detection method is described and presented in the following steps:
Step 1: Preprocess raw text to split a document into sentences and words, find part-of-speech tags (POS tags), and digitize data;

Current deep learning algorithms compute based on numbers, but raw text only contains words. Therefore, converting this information into numerical forms is required to input it into computational models. First, the text must be split into sentences because current encoding models mostly deal with the sentence level. Each sentence is then split into words to serve the POS tagging and digitizing task. The reason why POS tags are employed is that triggers are predefined as nouns, verbs, or adjectives, so these tags could provide some useful features to the detection model. In short, this step processes a raw text to obtain two numerical lists, one of which contains word identities and the other consists of POS tag codes.

Regarding sentence splitting, an unsupervised learning method is employed to build a model for the identification of acronyms, common phrases, and words that start a sentence. This model is trained on a large corpus of text in a specific language before being used. For instance, the document “Mr. Biden will join 30 NATO leaders at the special, hastily organized meeting, then will go to a previously scheduled European Council summit. twenty-one of the European Union's 27 members belong to NATO, and it is possible that close NATO allies like Sweden and Finland will also attend the meeting.” will be separated into two sentences: “Mr. Biden will join 30 NATO leaders at the special, hastily organized meeting, then will go to a previously scheduled European Council summit.” and “twenty-one of the European Union's 27 members belong to NATO, and it is possible that close NATO allies like Sweden and Finland will also attend the meeting.” This model knows the dot in “Mr. Biden” is not a sign of a new sentence and the beginning of the sentence is not always capitalized as “twenty-one.”

Each split sentence is further divided into words. The splitting method relies on regular expressions and the use of whitespace. For example, the sentence “Mr. Biden will attend NATO's summit.” will be split into a list of words [“Mr.”, “Biden”, “will”, “attend”, “NATO”, “'s”, “summit”, “.”].

Once the word lists for each sentence have been collected, they are converted into numerical data. This stage requires a predefined vocabulary with frequent sub-words found in the corpus. Starting with the current word, this method searches the vocabulary for the longest sub-word and then splits it into two units that contain this sub-word. The other unit is handled in the same manner as described above until all units have been digitized. For example, the word “hugs” has the longest sub-word in the vocabulary “hug”, so it is divided into “hug” and “##s”. Turning to the sub-word “##s”, because it is already in the dictionary, the final result is [8363; 1116] for the two sub-word codes of [“hug”, “##s”]. If the sub-words are not in the vocabulary, the word's digitization yields the special character “[UNK]” with code 100.

In addition to sentence separation, word separation, and word digitization, this stage also performs POS tagging of each word and converts it into a numerical form. POS tags are automatically recognized using a pre-trained language model. Then, a lookup table is used to get the numeric value corresponding to each tag. Considering a split sentence: [“Mr.”, “Biden”, “will”, “attend”, “NATO”, “'s”, “summit”, “.”], the identification results are [NNP, NNP, MD, VB, NNP, NNP, NNP, PUNCT] and their referring codes are [1,1,2,3,1,1,1,1,10]. Where: NNP is a singular proper noun, MD is a modal verb, VB is a verb in base form, and PUNCT is punctuation.
Step 2: Encode digitized words and their POS tags into vectors;

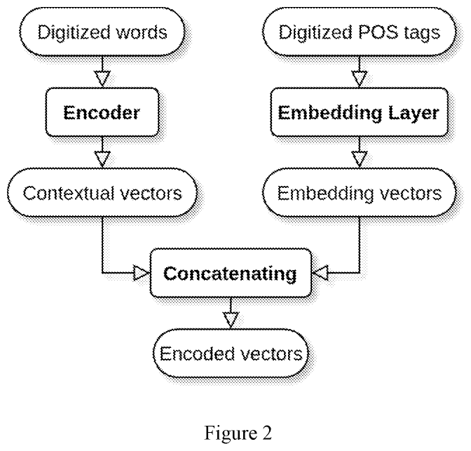

The meaning of the word in the context of the sentence is an important feature for conducting event classification. Furthermore, the POS tag is also a sign of the trigger word. To utilize these kinds of information, features must be extracted as vectors with a predefined number of dimensions. This process takes the output from the previous step as its input, and the outcome is a list of encoded vectors corresponding to each word in the sentence. FIG. 2 depicts the entire process as follows:

To begin, numbers representing the word in a sentence are fed into the encoder to find the semantic vector of each word. The symbol S={w₁, w₂, w₃, . . . , wₙ} represents the sentence S containing n digitized words from w₁ to wₙ, after passing it to the encoder En we obtain a set of contextual vectors V=En(S)={v₁, v₂, v₃, . . . , vₙ}. Each vector vᵢ contains information about the meaning of the wᵢ word as well as the entire sentence's context. For instance, the two sentences “The sink is in the kitchen.” and “The plane sinks into the river.”, both contain the sub-word “sink” but their meanings are different, so the two semantic vectors of the two words have a large distance. The En encoder is principally a pre-trained deep learning language model, but in this invention, its parameters are updated during training to ensure the best quality for the process.

The POS tag's code tᵢ is then fed into an embedding layer Em one by one to extract the relevant features. After this step, an embedded vector pᵢ=Em(tᵢ) is created. This embedding layer is also a deep learning model, acting as a mapping table from the single-dimensional space R¹ to the m-dimensional space R^{m}. The m-value is a training hyperparameter that can be improved based on the evaluation of the cross-validation dataset.

Finally, each vᵢ and pᵢ vector are combined to form a single encoded vector Vᵢ:

$${V}_{i} = [ \begin{matrix}{v}_{i} \\ {p}_{i}\end{matrix} ] \qquad ( 1 )$$

Suppose vᵢ is a k-dimensional vector and pᵢ is an m-dimensional vector, the dimension of the obtained vector Vᵢ is (k+m)
Step 3: Detect triggers and their event types.

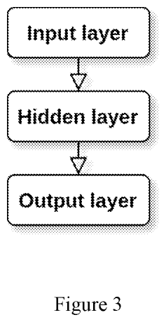

This step is to locate the triggers and classify their event types in a sentence by a neural network, which has the architecture shown in FIG. 3. This model comprises an input layer, a hidden layer, and an output layer, where the output value of the l-th layer depends on the previous layer with h neurons as described in formula (2). The input layer is also the output data of step 2, so it has a size of (k+m). The hidden layer is the middle one, which contains h₁ neurons, and this value can be tuned during training. The output of this network is a vector e with E elements, where E is the number of event types to be classified. The proposed model can perform both the identification and classification tasks by categorizing a word into E classes, where the “NONE” class indicates that it is not a trigger and the remaining classes are events denoted as “DIE”—“Die”, “INJ”—“Injured”, “BUY”—“Buy”, “MEET”—“Meet”.

$${a}_{i}^{l} = σ ( {\sum }_{h} {w}_{i k}^{l} {a}_{k}^{l - 1} + {b}_{i}^{l} ) \qquad ( 2 )$$

where, a is the output of the neuron, w and b are the weights of the neuron that need to be updated, l is the layer index of the neural network, i, k is the position of the neuron in a layer, h is the total number of neurons in a layer, and σ is the activation function.

The loss function used during training is a cross-entropy function in the form of the formula (3), where yᵢ and ŷₗ are the annotated and predicted event types of the word wᵢ, respectively.

$${L}_{1} = - {\sum }_{i = 1}^{n} {y}_{i} log ( \hat{{y}_{l}} ) \qquad ( 3 )$$

Step 4: Concatenate the surrounding encoded vectors of each trigger into an aggregate vector.

The aggregate feature vectors are prepared for the realis classification in this step. Using a list of encoded vectors from step 2 and trigger word positions from step 3, this process creates a vector for each trigger by joining vectors around it. Specifically, the number of neighboring vectors on the left is chosen as l and on the right as r. l is usually equal to r, and these values are adjustable during training. For the trigger with index j in the sentence, the result Vₒᵤₜ is performed as (4):

Vₒᵤₜ=[Vⱼ₋ₗ;Vⱼ₋ₗ₋₁; . . . ;Vⱼ; . . . ;Vⱼ₊ᵣ₋₁;Vⱼ₊ᵣ]^{T} (4)

where, Vⱼ is the j-th word's encoded vector that is obtained from step 2, T is the matrix transposition symbol.

In some special cases, the trigger word may be at the beginning or end of a sentence. As a result, the index of neighboring words may be outside the sentence's index limit. Meanwhile, the size of Vₒᵤₜ must be a fixed number and equal to (r+l+1)×(k+m), so the zero vector Z=[0; 0; . . . ; 0]^{T} is used to compensate for the missing vector positions.

Considering the sentence [“Mr.”, “Biden”, “will”, “attend”, “NATO”, “'s”, “summit”, “.”] whose output after the coding step is [V₀, V₁, V₂, V₃, V₄, V₅, V₆, V₇]. Suppose l=r=4 and the trigger index j=3 corresponds to the word “attend” which has the event type “Meet”. The result of this step is the vector [Z; V₀; V₁; V₂; V₃; V₄; V₅; V₆; V₇]^{T}.
Step 5: Classify the realis status of each event.

In this step, the model ingests the vector Vₒᵤₜ to generate the classification label of three realis statuses: “ACTUAL”, “GENERIC” and “OTHER”. In particular, the term “ACTUAL” refers to events that have occurred, are currently happening, or are about to take place, and they must be specifically confirmed in the document; the term “GENERIC” refers to events without a specific participant, location, or time; the remaining events, such as believed events, hypothetical events, and negated events, are annotated as “OTHER”.

FIG. 3 illustrates the structure of the employed neural network. This model has h₂ hidden layers and a three-dimensional output. Similarly to step 3, each neuron at the output layer represents a realis status. In terms of the loss function in the training stage, the cross-entropy function is also chosen with a computation similar to formula (3), but the loss value in this step is L₂.

In general, the proposed method uses four deep learning models, including a word encoder and an embedding layer in step 2, as well as two neural networks in steps 3 and 5. The encoder's weights have already been trained, so they only need to be initialized and updated from a checkpoint. However, the embedding layer and neural networks must be trained from scratch. All of the above models are trained together with the aggregate loss function L calculated as the formula (5), where α is the coefficient controlling the influence of each component loss function (0<α<1).

L=αL₁+(1−α)L₂ (5)

The training approach is based on a backpropagation algorithm combined with an optimization method. Backpropagation can calculate the gradient of the loss function for each of the network's weights. The gradient value is then fed into the optimizer, which uses it to update the weights to minimize the loss function. The chosen optimizer is ADAM, a stochastic gradient descent method based on adaptive estimation of first- and second-order moments. Equation (6) explains how this optimizer updates the model weights:

$$\{ \begin{matrix}{m}_{t} = {β}_{1} {m}_{t - 1} + ( 1 - {β}_{1} ) {g}_{t} \\ {v}_{t} = {β}_{2} {v}_{t - 1} + ( 1 - {β}_{2} ) {g}_{t}^{2} \\ = \frac{{m}_{t}}{1 - {β}_{1}^{t}} \\ \hat{{v}_{t}} = \frac{{v}_{t}}{1 - {β}_{1}^{t}} \\ {θ}_{t + 1} = {θ}_{t} - \frac{η}{\sqrt{\hat{{v}_{t}}} + ε} \hat{{m}_{t}}\end{matrix} \qquad ( 6 )$$

where, mₜ is the aggregate of gradients at time t (first-order moment vector), vₜ is the sum of square of past gradients (second-order moment vector), gₜ is the gradient at time t; β₁ and β₂ are hyperparameters (moving average parameters), ε is a small positive constant, η is the learning rate, θₜ is the weight at time t.

The training process also includes tuning hyperparameters to achieve the best results. These parameters in the invention consist of: the embedding vector dimension m; the number of neurons in the hidden layer h₁, h₂ in step 3 and 5, respectively; the number of neighboring vectors l, r; and the coefficient α. First, a list of the values of each hyperparameter is created. Due to the large search space, the random search method is preferred over the grid search approach during the tuning process. Accordingly, instead of executing all points in the grid, this method simply resorted to a randomly selected subset. At each point, we perform training and evaluation based on the cross-validation dataset. Finally, we select the best set of hyperparameters to ensure the system's quality.

The output of the proposed solution is described in the following three texts and their corresponding results:
Text 1: “Apple has acquired AI Music, a startup that uses artificial intelligence to generate personalized soundtracks and adaptive music.”

The trigger, its event type, and realis in this text are, respectively:
“acquired”: “Buy”—“ACTUAL” (this event is stated as occurring in the past).
Text 2: “If Elon Musk does buy Twitter, free speech absolutism will not be enough.”

In this text, the trigger, its event type, and realis are as follows:
“buy”: “Buy”—“OTHER” (this is a hypothetical event).
Text 3: “Mr. John thinks the meeting helped them solve the problem. However, he could not meet his partner due to COVID-19.”

The following are the trigger, event type, and realis in this text, respectively:
“meeting”: “Meet”—“GENERIC” (the event is mentioned in a non-specific way and there is no mention of any participant, place, or time of this meeting).
“meet”: “Meet”—“OTHER” (this event did not happen).

What is claimed is:

1. A detection method for factual events in online news, comprising the following steps:
Step 1: preprocess raw text of the online news to split a document into sentences and words, find part-of-speech tags (POS tags), and digitize data;
this step processes a raw text to obtain a first and a second numerical list; one of said first and second lists contains word identities, and the other of said first and second lists consists of POS tag codes, including the following stages:
sentence splitting: employing an unsupervised learning method to build a model for identification of acronyms, common phrases, and words that start a sentence, wherein the model is trained on a large corpus of text in a specific language before being used;
word splitting: each split sentence is further divided into words, wherein a splitting method is based on regular expressions combined with the use of whitespaces;
word digitalization: this step requires a predefined vocabulary with frequent sub-words found in the large corpus, starting with a current word, this method searches a vocabulary for a longest sub-word and then splits it into two units that contain this sub-word, the other unit is handled in the same manner as described above until all units have been digitized;
POS-tagging and digitalization: POS tags are automatically recognized using a pre-trained language model, then, a lookup table is used to get a numeric value corresponding to each tag;
Step 2: Encode digitized words and their POS tags into vectors;
this process takes a result from the previous step as its input, and an outcome is a list of encoded vectors corresponding to each word in the sentence, including the following stages:
tp begin, numbers representing the word in a sentence are fed into an encoder to find a semantic vector of each word, the symbol S={w₁, w₂, w₃, . . . , wₙ} represents the sentence S containing n digitized words from w₁ to wₙ, after passing it to the encoder En we obtain a set of contextual vectors V=En(S)={v₁, v₂, v₃, . . . , vₙ}, each vector vᵢ contains information about a meaning of the wᵢ word as well as the entire sentence's context, wherein the En encoder is principally a pre-trained deep learning language model, wherein the En encoder parameters are updated during training to ensure a best quality for the process;
the POS tag's code tᵢ is then fed into an embedding layer Em one by one to extract relevant features, after this step, an embedded vector pᵢ=Em(tᵢ) is created, the embedding layer is also a deep learning model, acting as a mapping table from a single-dimensional space R¹ to an m-dimensional space R^{m}, the m-value is a training hyperparameter that can be improved based on evaluation of a cross-validation dataset;
combining each vᵢ and pᵢ vector to form a single encoded vector Vᵢ:
$${V}_{i} = [ \begin{matrix}{v}_{i} \\ {p}_{i}\end{matrix} ] \qquad ( 1 )$$
suppose vᵢ is a k-dimensional vector and pᵢ is an m-dimensional vector, the dimension of the obtained vector Vᵢ is (k+m);
step 3: detect triggers and their event types;
this step locates the triggers and classify their event types in a sentence using a neural network, this model comprises an input layer, a hidden layer, and an output layer, where the output value of the l-th layer depends on the previous layer with h neurons as described in formula (2),
$${a}_{i}^{l} = σ ( {\sum }_{h} {w}_{i k}^{l} {a}_{k}^{l - 1} + {b}_{i}^{l} ) \qquad ( 2 )$$
because the input layer is also the step 2 output data, it has a size of (k+m), the hidden layer is the middle layer that contains h₁ neurons, and this value can be tuned during training, the output of this network is a vector e with E elements, where E is a number of event types to be classified, wherein the proposed model can perform both the identification and classification tasks by categorizing a word into E classes, where the “NONE” class indicates that it is not a trigger and the remaining classes are events denoted as “DIE”—“Die”, “INJ”—“Injured”, “BUY”—“Buy”, “MEET”—“Meet,
$${a}_{i}^{l} = σ ( {\sum }_{h} {w}_{i k}^{l} {a}_{k}^{l - 1} + {b}_{i}^{l} )$$
where, a is the output of the neuron, w and b are the weights of the neuron that need to be updated, l is the layer index of the neural network, i, k is the position of the neuron in a layer, h is the total number of neurons in a layer, and σ is the activation function;
the loss function used during training is a cross-entropy function in the form of the below equation, where yᵢ and ŷₗ are the annotated and predicted event types of the word wᵢ, respectively,
$${L}_{1} = - {\sum }_{i = 1}^{n} {y}_{i} log ( \hat{{y}_{l}} )$$
step 4: concatenate surrounding encoded vectors of each trigger into an aggregate vector;
preparing aggregate feature vectors for a realis classification in this step, using a list of encoded vectors from step 2 and trigger word positions from step 3, this process creates a vector for each trigger by joining vectors around it, wherein the number of neighboring vectors on the left is chosen as l and on the right as r, l is usually equal to r, and these values are adjustable during training, for the trigger with index j in the sentence, the result Vₒᵤₜ is performed as (4):
Vₒᵤₜ=[Vⱼ₋ₗ;Vⱼ₋ₗ₋₁; . . . ;Vⱼ; . . . ;Vⱼ₊ᵣ₋₁;Vⱼ₊ᵣ]^{T} (4)
where, Vⱼ is the j-th word's encoded vector that is obtained from step 2, T is the matrix transposition symbol;
in some special cases, the trigger word may be at the beginning or end of a sentence, as a result, the index of neighboring words may be outside the sentence's index limit, meanwhile, the size of Vₒᵤₜ must be a fixed number and equal to (r+l+1)×(k+m), so the zero vector Z=[0; 0; . . . ; 0]^{T} is used to compensate for the missing vector positions;
step 5: classify the realis status of each event;
ingesting model the vector Vₒᵤₜ to generate the classification label of three realis statuses: “ACTUAL”, “GENERIC” and “OTHER”, wherein the term “ACTUAL” refers to events that have occurred, are currently happening, or are about to take place and they must be specifically confirmed in the document; the term “GENERIC” refers to events without a specific participant, location, or time; the remaining events, such as believed events, hypothetical events, and negated events, are annotated as “OTHER”;
the employed model is a neural network that has h₂ hidden layers and a three-dimensional output, in a manner corresponding to step 3, each neuron at the output layer represents a realis status, in terms of the loss function in the training stage, the cross-entropy function is also chosen with the same computation method, and the loss value in this step is L₂:
L₂=−Σᵢ₌₁ⁿyᵢ log(ŷₗ).
